(19) United States
(12) Patent Application Publication
(10) Pub. No.: US 2022/0136140 A1
(43) Pub. Date: May 5, 2022

(54) NOVEL NANO-RIBBONS FROM MULTILAYER COEXTRUDED FILM

(71) Applicant: 3M INNOVATIVE PROPERTIES COMPANY, St. Paul, MN (US)

(72) Inventors: Kristy A. Jost, Woodbury, MN (US); Liyun Ren, Woodbury, MN (US); Rongzhi Huang, Woodbury, MN (US); William J. Kopecky, Hudson, WI (US); James M. Jonza, Lake Elmo, MN (US); Andrew J. Ouderkirk, Kirkland, WA (US)

(21) Appl. No.: 17/434,454

(22) PCT Filed: Feb. 26, 2020
(86) PCT No.: PCT/IB2020/051640

§ 371 Date: Aug. 27, 2021

Related U.S. Application Data
(60) Provisional application No. 62/812,020, filed on Feb. 28, 2019.

(51) Int. Cl. D01D 5/42; B29C 48/21; D01F 8/14; D01F 8/06

(52) U.S. Cl. CPC D01D 5/426; D01F 8/06; D01F 8/14; B29C 48/21

(57) ABSTRACT

The present invention is a process for converting a multilayer film to a plurality of nano-ribbons. The process includes co-extruding a first film and a second film to form the multilayer film, slitting the multilayer film to form a plurality of multilayer ribbons, and separating the multilayer ribbons to form a plurality of nano-ribbons having substantially flat cross-sections.

### FIELD OF THE INVENTION

The present invention relates generally to the field of nano-ribbons. In particular, the present invention relates to a nano-ribbon produced from a multilayer film.

### BACKGROUND

Strong, light, and inexpensive materials are often sought after for their unique properties. For example, such materials have a high surface area and a low weight-to-strength ratio useful in light-weighting transportation, filtration, insulation, and apparel. In particular, nano-fibers (<500 nm diameter) have unique characteristics compared to micro-fibers, such as higher surface area and extremely high porosity in non-woven films. Their applications range from uses in batteries as porous membrane separators to biomedical applications as cellular scaffolds to high surface area filters. Current nano-fiber fabrication methods include electrospinning, centrifugal spinning, and melt-blowing. Although there are many benefits of nano-fibers, a key barrier in the wide-scale adoption of the material is their significantly higher cost compared to microfibrous meltblown media, which are produced an order of magnitude faster.

One of the challenges to electrospun and meltblown nano-fibers is that they have very little orientation and are thus typically weaker than a drawn/oriented fiber from traditional fiber processing. The strongest fully oriented filament microfibers currently found in the industry are spun and drawn from the extruder (for example, at about 7000 m/min) and are typically also post-drawn to further increase the orientation. These fibers are used in applications such as ropes, tent fabrics, boating sails, architectural textiles, and other industrial textiles that require high tensile strength.

Currently, electrospinning and melt blowing processes do not easily allow for nano-fibers to be length oriented to the degree of melt spun filament fibers, nor can yarns and subsequently knitted/woven textiles be easily produced from the fibers made by these methods.

### SUMMARY

In one embodiment, the present invention is a process for converting a multilayer film to a plurality of nano-ribbons. The process includes co-extruding a first film and a second film to form the multilayer film, slitting the multilayer film to form a plurality of multilayer ribbons, and separating the multilayer ribbons to form a plurality of nano-ribbons having substantially flat cross-sections.

In another embodiment, the present invention is a nano-ribbon yarn including ribbons having a thickness of between about 10 nanometers and about 10 microns, wherein the ribbons have a substantially flat cross-section.

### BRIEF DESCRIPTION OF THE DRAWINGS

FIG. 1 is a cross-sectional, perspective view of an embodiment of a multilayer film used to make the nano-ribbons of the present invention.

FIG. 2 is a diagram of an embodiment of producing the nano-ribbons of the present invention.

FIG. 3 is side perspective view of an embodiment of the nano-ribbons of the present invention having varying thicknesses along the length

FIG. 4 is a cross-sectional, perspective view of an embodiment of the nano-ribbons of the present invention having a porous structure.

FIG. 5 is a cross-sectional, perspective view of an embodiment of the nano-ribbons of the present invention having discontinuous sections of resin.

FIG. 6 is a cross-sectional, perspective view of an embodiment of the nano-ribbons of the present invention having blends of two resins.

FIG. 7 shows a photograph of a multilayer ribbon and nano-ribbon yarn separated on one side by compressed air.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

The present invention is a nano-ribbon and a method of producing the nano-ribbon. In one embodiment, the nano-ribbons are highly oriented and have increased tensile strength and can be produced as bundles of ribbons or fibers (i.e., yarns), that can be woven or knitted into various textiles. Due to their increased tensile strength, the nano-ribbons can be used in a vast range of applications in addition to nonwovens. In addition, the resulting nano-ribbons can also be chopped and formed into a nonwoven fabric. The resulting nano-ribbons can provide a thin, yet warm material. Without being bound by theory, it is believed that the nano-ribbons provide warmth due to their inducement of the Knudsen Effect. Once pore sizes approach the size of the mean free path of air (73 nm), air molecules collide with the matrix (nanofibers) more often, losing energy with each collision, making heat transfer slower, and resulting in much better insulation. Thus, less material is needed to provide a greater deal of warmth.

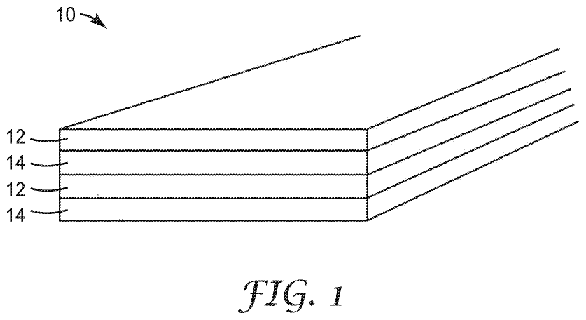

FIG. 1 shows a cross-sectional view of an embodiment of a multilayer film 10 used to make the nano-ribbons of the present invention. The multilayer film 10 used to create the nano-ribbons includes alternating layers of melt extrudable polymers or resin materials 12 and 14 that are immiscible with each other. The alternating layers of extrudable polymers or resins 12 and 14 have substantially no chemical affinity for each other but are still able to be extruded into a layered structure with each other. In one embodiment, the polymers may be length oriented at the same drawing temperatures, ratios and rates. In certain multilayer embodiments, one of the polymers is typically not able to be drawn, but the nano-layer stack can be drawn, extending the temperature/rate/ratio window beyond the normal conditions when multilayered. The multilayer film 10 includes at least two different melt extrudable polymers or resin materials 12 and 14, as depicted in FIG. 1, but may include more than two alternating layers without departing from the intended scope of the present invention. In one embodiment, the multilayer film used to create the nano-ribbon is an optical film.

The alternating polymer or resin layers, or polymer or resin pairs 12 and 14, may include, but are not limited to: polyethylene terephthalate (PET) and polypropylene (PP) or polyethylene (PE), polyamides PA6, PA66, PA11, PA12, PA46 and PP or PE, polyamides PA6, PA66, PA11, PA12, PA46 and polylactic acid (PLA) or polyhydroxyalkanoates (PHA), thermoplastic polyurethane (TPU) and PP or PE, styrenic block copolymers (e.g, styrene-ethylene/butylene-styrene (SEBS)) and PP or PE, transparent polymer (TPX) such as polymethylpentene (PMP) and PET, TPX and PP or PE, PP and PE, polybutylene terephthalate (PBT) and PP or PE, polylactic acid (PLA) and PP or PE, polybutylene succinate (PBS) and PP or PE, (PHA) and PP or PE, and hydrophobic/hydrophilic versions of the same polymer. Two particularly suitable polymer or resin pairs are PET and PP. If needed, in one embodiment, additives can be added to the base polymers that cause the alternating polymers to further reduce the chemical affinity to each other. It is to be understood that comonomers may also be polymerized with the majority monomer and still be considered under the class of polymer described. For example, some ethylene may be polymerized with propylene to increase the toughness of the PP, or a mixture of diols, diacids or diamines used in polymerizing any of the polyesters or any of the polyamides.

The individual layers can include a single polymer or resin material or may include more than one polymer or resin material. In one embodiment, an individual layer includes equal parts of two different polymer or resin materials. In another embodiment, an individual layer includes a majority (>50%) polymer or resin material and a minority (<50%) polymer or resin material. In one embodiment, the majority polymer or resin material is immiscible with the minority polymer or resin material.

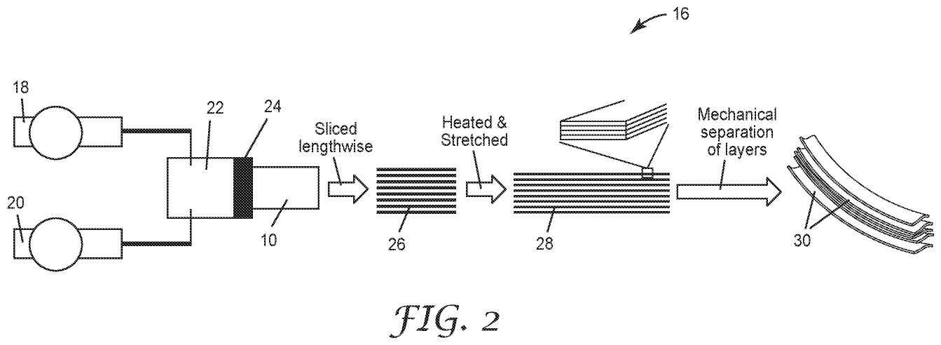

As previously stated, the multilayer film 10 must include at least two layers 12 and 14. However, the multilayer film 10 can include any number of layers without departing from the intended scope of the present invention. In one embodiment, the multilayer film includes up to about 1000 layers. In one embodiment, each of the layers of the multilayer film has a thickness of between about 1 and about 500 nm, particularly between about 50 and about 250 nm, and more particularly between about 50 and about 150 nm. FIG. 2 generally shows a method 16 of producing the nano-ribbons of the present invention. In a first step of producing the nano-ribbons of the present invention, the first polymer or resin material 12 passes through a first extruder 18 and the second, incompatible polymer or resin material 14 passes through a second extruder 20 into a multilayer feedblock 22. In one embodiment, the multilayer feedblock 22 is about 250 layers. In a next step, the stacked resin then flows through a film die 24 and is cooled on a chill roll to generate a multilayer film 10. The number of layers can be further increased with the use of a multiplier. In one embodiment, the process includes using a film die with small holes aligned in a single row perpendicular to the flow of the molten multi-layer stack coming from the feedblock 22. During extrusion, increasing the rate at which the chill roll is rotating down web compared to the linear velocity of the polymer stack out of the die can be used to increase the melt drawn orientation and reduce the thickness of all layers. The rheology of the polymer or resin materials of the multilayer film is an important consideration. Generally, the melt viscosities of the two resins at the temperature and shear rates of interest are within an order of magnitude or better to avoid flow instabilities (coextrusion defects). Following extrusion and cooling, the multilayer film 10 is slit lengthwise into ribbons 26. Because the multilayer ribbons 26 are formed from substantially flat layers of the extruded multilayer film, the resulting individual multilayered ribbons are substantially flat or ribbon-like, rather than having a cylindrical cross-section.

Once extruded and slit lengthwise, the multilayer ribbons 26 can be length oriented to be drawn thinner to create stretched multilayer ribbons 28. The multilayer film 10 can also be length oriented prior to slitting, both methods will impart sufficient orientation.

Orientation simply means that the long chains of polymers are oriented lengthwise in the same direction and can also impart higher crystallinity in the polymer. This improves the overall tensile strength of the material along the length because any force applied along the length is supported by the carbon backbone of the polymer, rather than the intertwining and entangling of the polymers chains. In one embodiment, the multilayer ribbons are stretched to a maximum of seven times their original length.

In one embodiment, the multilayered ribbons are length oriented at a ratio of about 7:1, particularly about 6:1, and more particularly about 5:1. In general, the draw ratio is set as high as possible for chain orientation, but not so high that there are numerous breaks. The multilayer ribbons can be length oriented by any method known to those of skill in the art. In one embodiment, orientation is achieved using a draw stand or a film length orienting machine, which heats and stretches the continuous filament fibers. This process also decreases the thickness of the multilayer ribbons, and therefore the individual layers. Generally, the higher the feed rate of the resin, the thicker the resulting layers. If desired, the speeds can be adjusted in line to produce a first region having a specified degree of orientation, and a second region having a different degree of orientation. In one embodiment, the multilayer ribbons are length oriented at a temperature of between about 60° C. and about 290° C., and particularly at about 100° C. Temperature is typically set at or above the glass transition temperature (Tg) of the polymers to make the material malleable enough to be stretched (i.e., length oriented). The faster the multilayer ribbons or multilayer films are being oriented, the higher the temperature can be increased in order to have sufficient heat transfer. For example, 290° C. is higher than the melt temperature (Tm) of PET, but if running at 1000 m/min, the PET is not in contact with the rollers long enough to melt. In one embodiment, the multilayer ribbons are being length oriented at a maximum speed of 100 m/min heated to 100° C.

Once length oriented, the layers of the multilayer ribbons 28 are physically separated, or delaminated, from each other to form single nano-ribbons 30. Because the alternating layers 12 and 14 of the multilayer film are immiscible with each other and have very little chemical affinity for each other, the layers can be easily separated from each other. The incompatible layers allow for the materials to be coextruded together but to also easily come apart from each other once solidified and agitated. Upon delamination, there is a clear single layer separation for most layers, which are the continuous filament nano-ribbons. The multilayer ribbons 28 are separated without the use of any sacrificial polymers that are dissolved away. In one embodiment, the multilayer ribbons 28 are separated by mechanical or chemical methods.

Examples of suitable methods of mechanical separation include, but are not limited to: compressed air (i.e., pneumatic texturizer), high pressure water (hydroentanglement), sonication, and ultrasonication. It should be noted that it is the velocity and/or the kinetic energy of the fluid (gas, air, liquid, water, etc.) and not necessarily the set pressure on the separation device that causes the separation to occur. An example of a suitable method for chemically separating the layers includes, but is not limited to, treating with a polar solvent.

Upon orientation, the polymer chains are aligned, increasing crystallinity and density. The reduction in volume may contribute to a reduction in adhesion between the layers or between fibers within layers.

The nano-ribbons 30 produced by separating the multilayered ribbons 28 have one or more layers. In the majority of the volume, each layer within the multilayer ribbon is separated into single sheets comprising one resin. In other embodiments, particularly at extremely small scales <500 nm, Van der Waals forces can become strong enough that some layers may remain together in groups of two or more. The nano-ribbons can be designed to be composed of more than one layer, such as three layers, where the outermost layers are composed of polymers or resins that will separate from each other, but not from the innermost layers. These multilayer nano-ribbons can be designed to be functionally layered to perform other functions, such as having shape memory properties, wicking, charged filtration, or many others where a function can be derived using more than one layered resin and may or may not have different additives in each layer.

The individual nano-ribbons are a thin, flexible material having a much longer length than width, with sufficient strength and length, and/or fiber-fiber friction when bundled in a yarn, to be used in a textile. Each of the nano-ribbon layers have a continuous or cut length. The nano-ribbon width is dependent on the width of the slit multilayered film, which can be as wide as about 5 mm. The thickness of the resulting nano-ribbons produced using the method of the present invention can be between about 1 and about 1000 nm, particularly between about 1 nm and about 500 nm, and more particularly between about 50 nm and about 150 nm. When the layers of the multilayer ribbons are mechanically separated with aggressive water jets or spinning micro-blades, the width can be further fibrillated, with resulting nano-ribbons having an average width of between about 1 μm and about 10 μm, particularly between about 2 μm and about 5 μm, and more particularly between about 2 μm and about 3 μm. The layer thickness of the resulting nano-ribbons is determined by a number of factors including, but not limited to: the number of extruded layers, the total film thickness, the density of the polymers or resins used, and the length orientation. Generally, the denser the resin, the thinner the resulting layers.

In one embodiment, the nano-ribbons have a thickness of between about 1 and about 500 nm and a width of between about 1 and about 50 μm.

The resulting nano-ribbons produced using the above method are highly fibrous with a look and feel similar to yarn and have high tensile strength and high surface area. The high tensile strength of the nano-ribbons is due to the length orientation step of the process of the present invention. In one embodiment, the nano-ribbons have a tensile strength of about between about 100 and about 325 MPa, particularly between about 107 and about 245 MPa, and more particularly between about 118 and about 211 MPa. In one embodiment, the nano-ribbons have a surface area of about 25 m²/g, particularly about 16 m²/g, and more particularly about 1.8 m²/g. In practice, because the nano-ribbons produced by the method of the present invention have a high surface area, they can stick easily to metal and other surfaces due to Van Der Waals forces and static electricity. Thus, in one embodiment, a lubricant, such as a silicone lubricant, can be coated onto the nano-ribbons for smoother processing.

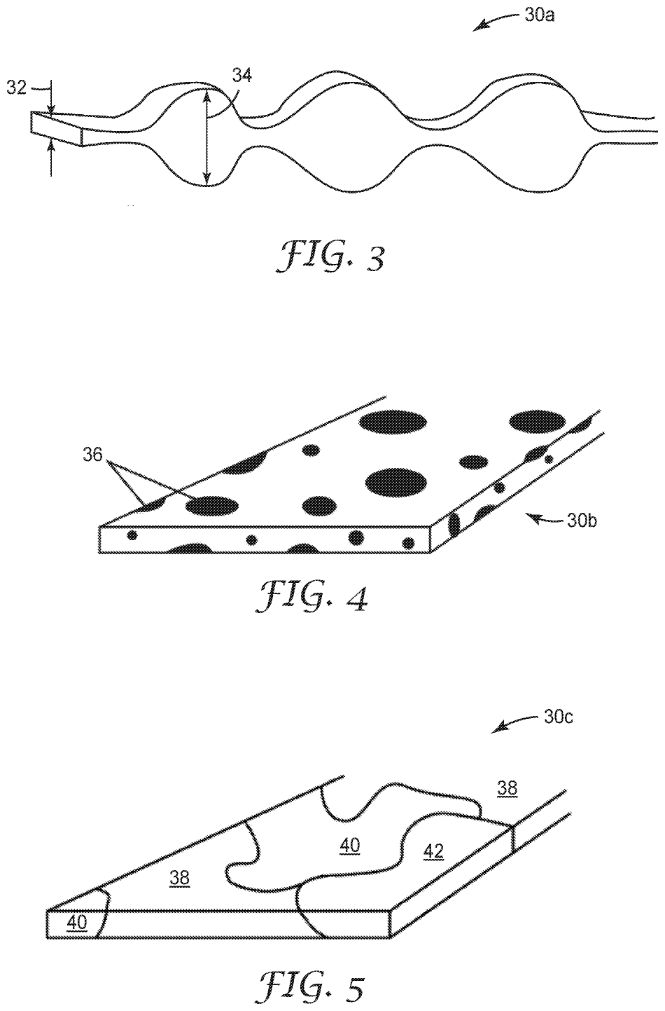

In one embodiment, the nano-ribbons can be designed to have a first region 32 with a first thickness and a second region 34 with a second, different thickness. FIG. 3 shows an embodiment of a nano-ribbon 30a having varying thicknesses along the length of the nano-ribbon. The varying thicknesses can be accomplished by drawing the multilayer film at intermittent speeds. One benefit of nano-ribbons having varying thicknesses is the creation of controlled non-uniformity, potentially to keep the substantially flat fibers from collapsing on each other, as is commonly seen in electrospun fibers. The nano-ribbons of each polymer type can also have different thicknesses which can be accomplished by varying the polymer type or the throughput of each polymer type from the extruders. For example, polypropylene can be run two times faster than polyester to obtain polypropylene layers that are thicker than the polyester layers.

In one embodiment, the nano-ribbons have a porous structure, as shown in FIG. 4. By including pores 36 in the nano-ribbons 30b, the surface area of the nano-fibers increases. According to the Knudsen effect, as pore size decreases, the thermal resistance increases exponentially. Thus, the size of the pores within the entire volume of the nano-ribbon or nano-ribbon yarn will affect the overall warmth that the nano-ribbon provides, which can be advantageous when used to produce a textile. The pores 36 can be created using any method known to those of skill in the art. In one embodiment, the pores 36 can be created using resins that are blended with the matrix resin that are then removed, either by heat, solubilized in water or solvent. In another embodiment, materials such as fluids and particles which expand, foam, or decompose can be used during the extrusion process to create the pores. Microvoids may also be induced by the extrusion and drawing conditions, in some cases promoted by solid particles that cannot get longer during the orientation.

FIG. 5 shows an embodiment of the nano-ribbons 30c including a first discontinuous section of resin 38, a second discontinuous section of resin 40, and a third discontinuous section of resin 42. Although FIG. 5 shows three discontinuous sections, any number of discontinuous sections of resin can be created without departing from the intended scope of the present invention. The discontinuous sections of resin can be created, for example, by using three different resins in a single extruder, all of which are incompatible with each other, that are ultimately blended together. To produce large discontinuous sections of varying resins, the volumetric amount of each resin must be relatively equal.

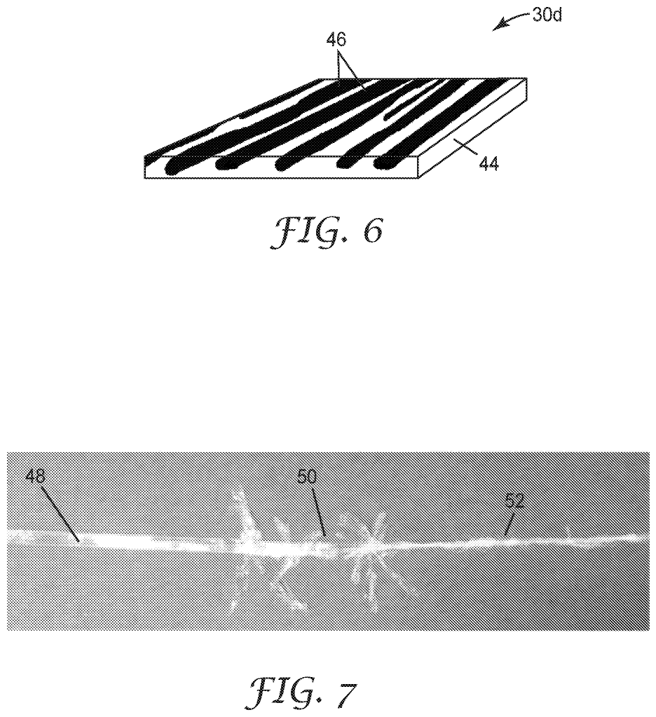

FIG. 6 shows yet another embodiment of the nano-ribbons 30d of the present invention, in which blends of two resins, a matrix 44 and a less dominant resin 46 are mixed in the extruders to create distinct regions of each resin. These layers are not only separated from each other, but the distinct regions of resin within the layers are also separated from each other to form even smaller, irregularly shaped nano-ribbons. To further aid in the separation of these even smaller segments of nano-ribbons, small amounts of a third polymer or resin material, such as polystyrene (PS), (i.e., 5 wt. % of the total) is added to sit between the base pair of polymer or resin materials, such as polyester and polypropylene. This type of blending may also be possible with other pairs.

The nano-ribbons produced by the method of the present invention can be formed into a yarn, which can then be formed into a textile, or a thin flexible sheet of material with sufficient strength and tear resistance (even when wet) to be used for clothing, interior fabrics, and other functional, protective or aesthetic applications. As used herein, “yarn” is defined as a thin material having a much longer length than width and is formed from many fibers to provide sufficient mechanical strength and flexibility to be converted to a textile (e.g., knit, woven, crochet etc.). Knitted, woven, crocheted, carpeted, and stitched textiles are made by looping and intertwining yarns together into sheets. The nano-ribbons 34 can be used in any number of fields. For example, they can be used as thermal insulation, as a filtration medium, as a highly absorptive material, as a dusting and cleaning material, or as a scaffold for growing cells of plant, animal, human, bacteria.

It is important to note, in one embodiment, when the multilayered ribbon (a film like material), is mechanically separated with compressed air, the material is not blown apart into disparate pieces that need to be recombined to form a yarn. Rather, because the layers are continuous along the length of the multilayer ribbon, each layer could be described as a continuous filament nanofiber, they are just adhered and stacked together in a larger filament (the multilayer ribbon). The mechanical agitation causes the layers to become individually separate, exposing their surface area, but are still intertwined together. The separated nano-ribbons are still held together in a strand that is soft to the touch and yarn-like instead. FIG. 7 shows a photograph of a multilayer ribbon and nano-ribbon yarn separated on one side by compressed air. “58” in FIG. 8 shows the intact multilayer ribbon 28, “50” shows the intersection where the multilayer ribbon begins to separate when exposed to compressed air, and “52” shows the resulting separated nano-ribbons 30 that are still held together in a yarn-like structure. It is also important to note that to those skilled in the art, one could also chop the strand of yarn into staple nano-ribbons and convert it to a calendared nonwoven web. Staple fibers are defined as short fibers typically 3 inches or less in length.

Because the method of producing the nano-ribbon is a high throughput manufacturing process, is solvent free, and does not need to use a sacrificial polymer to separate nanofibers from bulk, it is an economical method for producing ultrafine nano-ribbons or nano-fibers (<100 nm), particularly compared to electrospinning, melt blowing, and islands in the sea, which are inhibited by at least one of the above.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis.

### Example 1

A multilayer film comprised of 151 alternating layers of PET and PP with PET skins, was extruded using a 151 layer feedblock through a slotted film die. The PET grade used was 7352 supplied by Eastman Chemical Company (Kingsport, Tenn.), and the PP grade was 1024 supplied by Exxon Mobil Corporation (Irving, Tex.). Three extruders were used, a first extruder for the PET layers, a second for the PP layers, and a third for the PET skin layers. Skin layers are the two outermost layers used to protect the 151 inner layers.

They are often thicker than the inner layers and removed after extrusion is complete. The first extruder was set to 292° C. with a first necktube set to 271° C., the second extruder was set to 270° C. with a second necktube set to 282° C., and the third extruder was set to 287° C. with a third necktube set to 271° C. The necktubes connected and directed the resin from the extruders to the feedblock and die. The feedblock and die was set at 271° C. The first extruder was a twin screw with a barrel diameter of 27 mm and was operated at 40 rotations per minute (rpm), the second extruder was a twin screw with a barrel width of 18 mm and was operated at 104 rpm, and the third extruder was a single screw with a barrel width of 25 mm and was operated at 150 rpm. The multilayer film was extruded onto a chill roll set at 32° C., and further directed through a casting station and take up winder. The take up winder was set to 3.9, 6.4 and 8.5 meters per minute (m/min), resulting in films that were 190 μm, 114 μm, and 100 μm in total thickness and 14.5 cm wide.

In this example the skins were left on the films to allow for easier handling & processing. The multilayered film was then slit along the length, using a machine containing a series of aligned blades, into multilayer ribbons having width of 4.76 mm and 3.175 mm. The finished ribbons were then wound onto individual spools.

The thinnest multilayer ribbons (100 μm) were then length oriented on a draw stand supplied by Retech Aktiengesellschaft (Meisterschwanden, Switzerland) with 10 cm wide godet rolls heated to 100° C. at 6:1 (that is, 6 times the original length), the resulting multilayer ribbons were 20.86 μm thick, with the 151 layer stack comprising 10 μm width, 0.79 mm width and continuous in length. The individual layers were each measured to be 66 nm in thickness.

The length oriented multilayer film was then passed through a compressed air Heiberlein SLIDEJET DT15-2 (Wattwill Switzerland) nozzle with compressed air set at 30 psi and 10 m/min. The exposure to high velocity air caused the layers to separate, and the resulting material was a continuous fibrous string or nanoribbon yarn. When compressed air was set above 80 psi, the material would often break.

The new nanoribbon yarn was then observed under scanning electron microscopy (SEM), and using a Phenom ProX (Thermo Fisher Scientific, Waltham, Mass.). The images were scanned to determine a fiber thickness distribution. The average fiber thickness was ˜550 nm, with a measured distribution ranging from 100 nm up to 15 μm. And based on individual observations there is clearly a range of single layer nanofibers, as well as sets of 2-3 layers that remained adhered together, contributing to the distribution.

The nanoribbon yarn's accessible surface area was measured using 3M internal test method (CRAL SOP-000134) based on Brunauer—Emmett—Teller (BET) theory, a standard method to those skilled in the art. Instrument: Quantachrome Autosorb IQ (Quantachrome, Boynton Beach, Fla.). The cell type was 12 mm, No Bulb, with Rod. The sample mass was ˜0.3-1.0 g, strips were rolled tightly and inserted into the straight tubes.

The sample was degassed over 2 days under vacuum at room temperature using a Degasser (FLOVAC INC, Houston, Tex.). Leak tests were checked to guarantee complete removal of moisture. The following measurement conditions were used: Analysis Mode: Standard, Adsorbate: Kr, Po mode: User Entered 2.63 torr (Kr), Void Volume Re-measure: Off, Evacuation Cross-over Mode: Powder, Tolerance: 0, Equilibrium: 3, Points: 11 points evenly spaced from 0.05 to 0.30 P/Pₒ, selected the points in the range appropriate for multi-point BET analysis. The total surface area was determined to be 1.8 m²/g with a standard deviation of 0.005 m²/g.

To determine mechanical properties, the samples were prepared according to ASTM test method D2256-10(2015) and were 250 mm in length in the starting position between crossheads. The samples were tested on the MTS RF100 load frame supplied by Instron (Norwood, Mass.). Tensile testing was also completed from 10 samples, and broke at an average load of 3.8 N, and had an average break tenacity of 126 kN·m/kg.

The nanoribbon yarn was then coated in a water based Lurol ASM lubricant or spin finish supplied by Goulston Technologies (Monroe, N.C.) to improve processability during knitting. A single strand of the nanoribbon yarn was then knitted on a SWG041N2 15-gauge knitting machine supplied by Shima Seiki USA (Monroe Twp, N.J.), in a plain jersey stitch, set with a stitch value of 33. No supporting yarn was used to reinforce the nanoribbon yarn during knitting.

### Example 2

A multilayer film comprised of 151 alternating layers, each layer containing a combination of polymers, the first combination contained 80 wt. % PET/15 wt. % PP/5 wt. % PS, the second combination contained 65 wt. % PP/30 wt. % PET/5 wt. % PS, with 100 wt. % PET skins. These layers were extruded using a 151 layer feedblock through a slotted film die. The PET grade used was 7352 supplied by Eastman Chemical Company (Kingsport, Tenn.), and the PP grade was 1024 supplied by Exxon Mobil Corporation (Irving, Tex.), and the polystyrene (PS) grade EA 3400 was supplied by Americas Styrenics (Chanahon, Ill.). Three extruders were used, a first extruder for the first combination layers a second for the second combination layers, and a third for the PET skin layers. The first extruder was set to 293° C. with a first necktube set to 271° C., the second extruder was set to 271° C. with a second necktube set to 271° C., and the third extruder was set to 297 with a third necktube set to 276° C. The necktubes connected and direct the resin from the extruders to the feedblock and die. The feedblock and die was set at 271° C. The first extruder had a barrel diameter of 27 mm and was operated at 40 rotations per minute (rpm), the second extruder had a barrel width of 18 mm and was operated at 109 rpm, and the third extruder had a barrel width of 25 mm and was operated at 250 rpm. The multilayer film was extruded onto a chill roll set at 32° C., and further directed through a casting station and take up winder. The take up winder was set to 3.9, 6.4 and 8.5 meters per minute (m/min), resulting in films that were 190 μm, 114 μm, and 100 μm in total thickness and 14.5 cm wide.

The resulting multilayer films have discrete regions of polymer in each of the layers, with alternating major phases of PET or PP in each layer, and smaller spherical regions within each layer.

The skins on the final multilayer film of 100 μm were removed by hand, though this process could be automated as known to those skilled in the art. The multilayer film was then length oriented 6:1 in the machine direction on an Accupull automated orientation machine supplied by Inventure Laboratories Inc (Knoxville, Tenn.) and operated at 110° C. The length oriented multilayer film was then passed through pressurized water jets also known as hydroentanglement. The water mechanically separated the layers of the film, as well as fibrillated the film along the length into a fibrous nonwoven material, with nanoribbons as thin as 200 nm. The resulting fibers had different types of cross-sectional geometry, with the majority being substantially flat or ribbon-like, while some had cylindrical or eye-let shaped cross-sections. The substantially flat nano-ribbons were primarily the result of the first resin which comprised the majority of its individual layer, while the cylindrical fibers resulted from the second resin comprising the minority of its individual layer.

### Example 3

A multilayer film prepared in the same manner as example 2, was slit along the length by hand into multilayer ribbons having width of 4.76 mm and 3.175 mm. The multilayer ribbon was then length oriented on the draw stand described in example 1, at 90° C. at 6:1, with the 151 layer stack having a total thickness of 14.6 μm after orientation (not including the thickness of the skins). The individual layers were measured to be between about 91 nm and 600 nm, with the larger nanoribbons resulting from some of the phase separated sections of the second resin in the layers, and the smaller nano ribbons resulting from the first polymer. The skins were then removed by hand leaving only the 151 layer film. The multilayer ribbon was then passed through compressed air at 30 psi using the same procedure and equipment as Example 1, resulting in a fibrous mechanically separated nano-ribbon yarn. The resulting nano-ribbon cross-sectional geometries were the same as in Example 2.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

1. A process for converting a multilayer film to a plurality of nano-ribbons, the process comprising:
co-extruding a first film and a second film to form the multilayer film;
slitting the multilayer film to form a plurality of multilayer ribbons; and
separating the multilayer ribbons to form a plurality of nano-ribbons having substantially flat cross-sections.

2. The process of claim 1, further comprising length orientating the multilayer film.

3. The process of claim 1, further comprising length orientating the multilayer ribbons.

4. The process of claim 1, further comprising a plurality of first films and second films alternately layered.

5. The process of claim 1, wherein the first film is immiscible with the second film.

6. The process of claim 1, wherein separating the multilayer ribbons comprises mechanically or chemically separating the layers.

7. (canceled)

8. The process of claim 1, wherein the nano-ribbons have a tensile strength of at least about 90 kN-m/kg.

9. The process of claim 1, wherein the first film comprises polyester and the second polymer film comprises polypropylene.

10. The process of claim 1, wherein the first film comprises a combination of polymers.

11. The process of claim 1, wherein the first film comprises a first polymer and a second polymer, wherein the first polymer comprises a majority by weight of the first film, and wherein the first polymer is immiscible with the second polymer and the second film.

12. The process of claim 1, wherein the first film comprises a first polymer and a second polymer, wherein the first polymer of the first film is immiscible with the second polymer of the first film, and wherein the second film comprises a first polymer and a second polymer, wherein the first polymer of the second film is immiscible with the second polymer of the second film.

13. A nano-ribbon yarn produced by the process of claim 1.

14. A nano-ribbon yarn comprising ribbons having a thickness of between about 10 nanometers and 10 microns, wherein the ribbons have a substantially flat cross-section.

15. The nano-ribbon yarn of claim 14, wherein the ribbons comprise at least a first polymer and a second polymer.

16. The nano-ribbon yarn of claim 15, wherein the first polymer is immiscible with the second polymer.

17. The nano-ribbon yarn of claim 15, wherein the first polymer and the second polymer have little chemical affinity for each other.

18. The nano-ribbon yarn of claim 15, wherein the first polymer and the second polymer can be extruded into a layered structure with each other.

19. The nano-ribbon yarn of claim 15, wherein the first polymer comprises polyester and the second polymer comprises polypropylene.

20. The nano-ribbon yarn of claim 14, wherein the ribbons have a tensile strength of at least about 90 kN-m/kg.

21. A knitted fabric comprised of the nano-ribbon yarn of claim 14.
